(19) United States
(12) Patent Application Publication
(10) Pub. No.: US 2019/0285919 A1
(43) Pub. Date: Sep. 19, 2019

(54) DISPLAY DEVICE AND METHOD FOR MANUFACTURING THE SAME

(71) Applicant: Mitsubishi Electric Corporation, Tokyo (JP)

(72) Inventors: Kazushi KIYOTA, Kumamoto (JP); Takanori OKUMURA, Tokyo (JP)

(73) Assignee: Mitsubishi Electric Corporation, Tokyo (JP)

(21) Appl. No.: 16/276,042

(22) Filed: Feb. 14, 2019

(30) Foreign Application Priority Data
Mar. 19, 2018 (JP) 2018-050734

(51) Int. Cl. G02F 1/1333; C03B 33/033; B32B 7/12; B32B 17/06; B32B 37/12; B32B 37/18

(52) U.S. Cl. CPC G02F 1/1333; C03B 33/033; B32B 7/12; B32B 17/06; B32B 37/12; B32B 2457/202; G02F 2001/133302; G02F 2201/56; B32B 2307/412; B32B 2315/08; B32B 37/18

(57) ABSTRACT

There is provided a display device that is provided with a display panel having a non-rectangular outline that is incorporated in a curved state, the display panel including a glass substrate that is provided in its side along a curving direction of the display panel with an inflection point of an outline formed by at least one of the combination of curved lines or straight lines, and the combination of the curved line and straight line, the glass substrate including a curved portion in an arc-like shape with a first curvature radius in a portion including the inflection point of the outline, serving as an inflection-suppressing region for suppressing a variation in the side along the curved direction, the curved portion being formed to have the first curvature radius more than 5 mm.

### BACKGROUND OF THE INVENTION

### Field of the Invention

The present invention relates to a display device, and more particularly to a display device having a curved display surface.

### Description of the Background Art

A display device such as a liquid crystal display or an organic electro luminescence (EL) display is required to display a lot of information efficiently with good visibility in a limited space when being mounted in a train, a vehicle, or the like. The display device is also required to fit design of onboard equipment and installation position. That is, from the viewpoint of design and space saving, necessity of a curved display (referred to as a curved display device) has increased in recent years. From the same viewpoint, an outline of a display panel is not limited to a conventional rectangular outline, and thus necessity of an odd-shaped display having an odd-shaped (non-rectangular) outline (referred to as an odd-shaped display device), such as a polygonal outline, and an outline partly having a curve that includes a circular shape, a semicircular shape, a fan shape, and an elliptical shape, has increased. In addition, an odd-shaped-curved display (referred to as an odd-shaped-curved display device) formed by curving an odd-shaped liquid crystal panel acquired by combining a curved display and an odd-shaped display has gradually demanded. While there are not many related documents, development, trial production, and the like, have been gradually started.

Regarding an odd-shaped display, Japanese Patent Application Laid-Open No. 2004-212498 (Patent Document 1) discloses an odd-shaped display having a hexagonal outline in which two corners are obliquely cut from a rectangular outline, for example. In addition, Japanese Patent Application Laid-Open No. 2000-75257 (Patent Document 2) discloses an odd-shaped display having an outline including a curve partly. When a specific outline of an odd-shaped display is formed, a substrate mainly made of glass needs to be cut into the odd-shape. For example, when an odd-shaped display has a polygonal shape with only straight lines for cutting as disclosed in Patent Document 1, the odd-shaped display can be formed by a scribing process using a disc-like scribing wheel that is typically used for cutting a glass substrate, and a breaking process after the scribing process. While using this method enables a polygon to be formed by appropriately disposing a dummy pattern, for example, according to each linear portion constituting an outline of the polygon, there is a problem in that it is difficult to form a desired outline with good reproducibility, or with high yield, in the scribing process for a cutting line including a curved line as disclosed in Patent Document 2. Thus, there have been proposed a process of forming a groove serving as a starting point of cutting by patterning a protective layer corresponding to a desired outline, followed by etching using a chemical solution, and a cutting method by a subsequent break process.

Meanwhile, a curved display in which a glass substrate is curved in a specific direction as disclosed in Japanese Patent Application Laid-Open No. 2010-066462 (Patent Document 3) causes a problem in that when micro cracks are formed at the time of cutting two sides positioned on opposite sides with respect to a curved direction of the glass substrate, the substrate may crack when the glass substrate is curved. Thus, a method of removing the micro cracks by cutting end portions of the substrate obtained by cutting with chemical etching or the like has been proposed.

For example, in the case of forming an odd-shaped-curved display in which a polygonal odd-shaped display is curved as disclosed in Patent Document 1, when one corner of the polygon is formed at the glass end portion along a curved direction, micro cracks are more likely to occur at the corner than an end portion of a straight line. This also causes stress to tend to concentrate, so that there is a problem in that curving the glass substrate may cause a cullet defect causing glass cullet occurrence, a break-crack defect, and the like, resulting in low yield.

In addition, even in the case of forming an odd-shaped-curved display in which an odd-shaped display having an outline including a curved line as disclosed in Patent Document 2 is curved, micro cracks are likely to occur at a portion where a straight line intersects with a curve, or a portion where curves each with a different curvature intersect with each other. This also causes stress to tend to concentrate, so that there is a problem in that curving the glass substrate may cause a defect, such as a cullet defect, and a break-crack defect, resulting in low yield.

### SUMMARY

It is an object of the present invention to provide a display device that has a curved display panel in which an odd-shaped display panel is curved in a specific direction, and that suppresses defects generated when a glass substrate is curved.

A display device according to the present invention is provided with a display panel having a non-rectangular outline that is incorporated in a curved state, the display panel including a glass substrate that is provided in its side along a curved direction of the display panel with an inflection point of an outline composed of a combination of at least curves or straight lines, the glass substrate including an arcuate curved portion with a first curvature radius in a portion including the inflection point of the outline, serving as an inflection-suppressing region for suppressing a variation in the side along the curved direction, the curved portion being formed to have the first curvature radius exceeding 5 mm.

According to the display device described above, providing the inflection-suppressing region in the portion including the inflection point of the outline enables suppressing stress concentration at the time of curving the glass substrate, so that a display device suppressing defects occurring on the glass substrate can be obtained.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a sectional view illustrating a configuration of a curved liquid crystal display device of a first preferred embodiment of a display device according to the present invention;

FIG. 2 is a perspective view illustrating a configuration of the curved liquid crystal display device of the first preferred embodiment of a display device according to the present invention;

FIG. 3 is a flowchart illustrating a method for manufacturing a curved liquid crystal display device according to the first preferred embodiment of the present invention;

FIG. 4 is a view for illustrating a scribing process;

FIG. 5 is a view for illustrating a shape of a scribe line and a shape of an inflection-suppressing region of a liquid crystal panel;

FIG. 6 is a graph showing a relationship between a curvature radius of a curved portion provided in an inflection-suppressing region and a relative bending strength of a glass substrate when it is curved.

FIG. 7 is a perspective view illustrating a configuration of a curved liquid crystal display device according to a second preferred embodiment of a display device according to the present invention;

FIG. 8 is a view for illustrating a shape of a scribe line and a shape of an inflection-suppressing region of a liquid crystal panel;

FIGS. 9A and 9B are views each illustrating an application example 1 of a third preferred embodiment of the display device according to the present invention;

FIGS. 10A and 10B are views each illustrating an application example 2 of the third preferred embodiment of the display device according to the present invention;

FIGS. 11A and 11B are views each illustrating an application example 3 of the third preferred embodiment of the display device according to the present invention;

FIGS. 12A and 12B are views each illustrating an application example 4 of the third preferred embodiment of the display device according to the present invention;

FIG. 13 is a view for illustrating an application example 5 of the third preferred embodiment of the display device according to the present invention; and

FIG. 14 is a view for illustrating the application example 5 of the third preferred embodiment of the display device according to the present invention.

### DESCRIPTION OF THE PREFERRED EMBODIMENTS

### First Preferred Embodiment

<Device configuration>

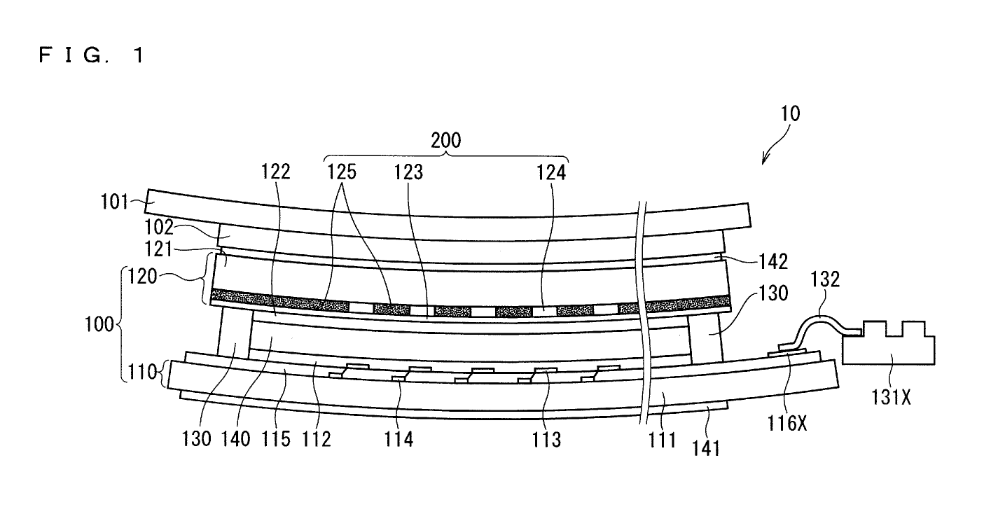

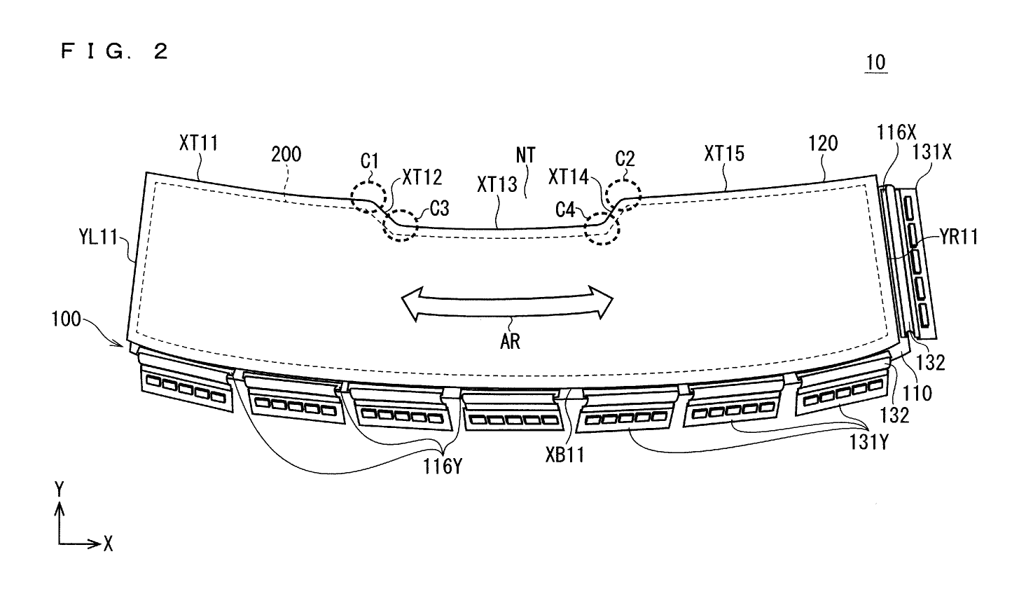

FIG. 1 is a sectional view illustrating a configuration of a curved liquid crystal display device 10 of a first preferred embodiment of a display device according to the present invention. FIG. 2 is a perspective view illustrating a configuration of the curved liquid crystal display device 10. In FIG. 2, a curved transparent protective cover 101 and the like are eliminated for the sake of convenience, and a perspective view of a liquid crystal panel 100 is illustrated.

FIGS. 1 and 2 each are a schematic view, and do not reflect an exact size of illustrated components, and the like. In addition, repetitive portions of display pixels are eliminated, and a part of various films is simplified. In the drawings, the same reference numerals are given to the same components as those described in previous drawings, and the description thereof will be eliminated. The same applies to the following drawings.

The curved liquid crystal display device 10 uses a thin film transistor (TFT) as a switching device. As illustrated in FIG. 1, when the liquid crystal panel 100 (display panel), which is a main component, is bonded and fixed to the curved transparent protective cover 101 that is a transparent protective plate including a holding surface having a curved surface with a predetermined curvature (curvature radius) with a transparent adhesive sheet 102 interposed therebetween, the liquid crystal panel 100 holds its curved shape, thereby enabling the liquid crystal panel 100 to be easily formed in a curved shape.

The liquid crystal panel 100 mainly includes a TFT array substrate (hereinafter referred to as an array substrate) 110 in which a plurality of TFTs is disposed in an array, a color filter substrate (hereinafter referred to as a counter substrate) 120 provided with a display surface 200 for displaying images, being disposed facing the array substrate 110, a sealing material 130 made of resin provided so as to surround a region corresponding to the display surface 200 between the array substrate 110 and the counter substrate 120, the sealing material 130 bonding both the substrates to each other, and a liquid crystal 140 sealed in a region corresponding to the display surface 200 between the array substrate 110 and the counter substrate 120 surrounded by the sealing material 130.

The curved liquid crystal display device 10 is formed to have an appearance curved with a predetermined curvature so as to be recessed toward the counter substrate 120 by bonding the curved transparent protective cover 101 to the counter substrate 120 with the transparent adhesive sheet 102 interposed therebetween. A curved direction is indicated as a curved direction AR along a longitudinal direction of the liquid crystal panel 100. The longitudinal direction is a direction (X-direction) along and with respect to lower sides of the array substrate 110 and the counter substrate 120, provided linearly, as illustrated in FIG. 2. In the curved direction AR, the curvature becomes maximum.

In addition, the liquid crystal panel 100 has a curved shape, and each of the array substrate 110 and the counter substrate 120, constituting the liquid crystal panel 100, has an outline in a non-rectangular complex odd-shape instead of a rectangular shape. That is, the liquid crystal panel 100 has an outline shape formed with a straight line and a curved line. More specifically, a notch portion NT in a recessed shape is formed on an upper side of the liquid crystal panel 100, the upper side being one of two sides in a lateral direction (Y-direction) perpendicular to the longitudinal direction of the liquid crystal panel 100, as illustrated in FIG. 2.

The notch portion NT has a length in X-direction considerably longer than that in Y-direction, and has a shallow and long cutout as a whole. Opposite ends of the notch are inclined in directions away from each other to form a contour shape opened upward facing the drawing.

The notch portion NT has four corner portions each of which is an arcuate curved portion having a predetermined curvature to suppress a great change in direction of the outline, and serves as an inflection-suppressing region.

Next, a detailed outline of the liquid crystal panel 100 will be described by taking respective sides constituting an outline of the counter substrate 120 illustrated in FIG. 2 as an example. As illustrated in FIG. 2, the counter substrate 120 has a left side YL11, a right side YR11, and a lower side XB11, facing the drawing, each of which is a straight line. In a state where the counter substrate 120 is not curved, the left side YL11 and the right side YR11 are perpendicular to the lower side XB11 in plan view. An upper side of the counter substrate 120 includes sides XT11 and XT15 positioned on opposite sides of the notch portion NT, a side XT13 constituting the bottom of the notch portion NT, and inclined sides XT12 and XT14 at opposite ends of the cutout of the notch portion NT, each of which is a straight line.

Between the sides XT11 and XT12 each extending at an angle different from each other, and between the sides XT15 and XT14 each extending at an angle different from each other, inflection-suppressing regions C1 and C2 are provided, respectively. The inflection-suppressing regions C1 and C2 are arcuate curved portions having a predetermined curvature so as to smoothly connect the adjacent sides to each other.

In addition, between the sides XT13 and XT12 each extending at an angle different from each other, and between the sides XT13 and XT14 each extending at an angle different from each other, inflection-suppressing regions C3 and C4 are also provided, respectively. The inflection-suppressing regions C3 and C4 are arcuate curved portions having a predetermined curvature so as to smoothly connect the adjacent sides to each other.

The relationship between the arcuate curved portions each having the predetermined curvature provided in the corresponding inflection-suppressing regions C1 to C4, and straight portions on the corresponding opposite sides thereof will be described in detail later.

While the array substrate 110 has an outline in which a lower side and a right side, facing the drawing, are provided so as to extend slightly from the outline of the counter substrate 120, other sides are provided to coincide with the outline of the counter substrate 120. The outline of the array substrate 110 basically has the same features as those of the outline of the counter substrate 120 described above, and thus duplicated description will be eliminated.

Next, a specific configuration of each of the array substrate 110 and the counter substrate 120 will be described with reference to FIGS. 1 and 2. First, the array substrate 110 includes a glass substrate 111 that is a transparent substrate, and that is provided on its one main surface with an alignment film 112 for aligning the liquid crystal 140 in a region corresponding to the display surface 200, pixel electrodes 113 provided under the alignment film 112 to apply voltage to drive the liquid crystal 140, a TFT 114 for supplying voltage to the pixel electrode 113, an insulating film 115 for covering the TFT 114, a gate wiring and a source wiring, which are not illustrated, for supplying a signal to the TFT 114, and the like.

Outside a region corresponding to the display surface 200, the array substrate 110 further includes a terminal 116 for receiving a signal to be supplied to the TFT 114, from the outside, a transfer electrode (not illustrated) for transmitting the signal received from the terminal 116 to a counter electrode, and the like. The glass substrate 111 is further provided on its other main surface with a polarizing plate 141. The terminal 116 includes a terminal 116X provided at a right end portion of the array substrate 110 in X-direction, and a terminal 116Y provided at a lower end portion of the array substrate 110 in Y-direction.

Meanwhile, the counter substrate 120 includes a glass substrate 121 that is a transparent substrate, and that is provided on its one main surface with an alignment film 122 for aligning the liquid crystal 140, a common electrode 123 disposed under the alignment film 122 to drive the liquid crystal 140 by generating an electric field between the pixel electrodes 113 on the array substrate 110 and the common electrode 123, collar filters 124 and light shielding layers (black matrix (BM)) 125, provided under common electrode 123, and the like. The glass substrate 121 is further provided on its other main surface with a polarizing plate 142.

The glass substrate 111 and the glass substrate 121 constituting the array substrate 110 and the counter substrate 120, respectively, are reduced in thickness to about 0.2 mm so as to have flexibility.

The array substrate 110 and the counter substrate 120 are adhered to the sealing material 130 and a spacer (not illustrated) interposed therebetween, the spacer holding a predetermined distance between the substrates. As the spacer, granular spacers dispersed on the substrate may be used, or a columnar spacer formed by patterning a resin on any one of the substrates may be used.

The transfer electrode and the common electrode 123 are electrically connected by a transfer material (not illustrated), and a signal received from the terminal 116 is transmitted to the common electrode 123. In addition to these, the liquid crystal panel 100 includes a control substrate 131 mounted with a driving integrated circuit (IC) or the like for generating a driving signal, a flexible flat cable (FFC) 132 that is a film-like wiring for electrically connecting the control substrate 131 to the terminal 116, and the like. The control substrate 131 includes a control substrate 131X electrically connected to a terminal 116X provided at a right end portion of the array substrate 110 in X-direction, and a control substrate 131Y electrically connected to a terminal 116Y provided on a lower end portion of the array substrate 110 in Y-direction.

A backlight unit (not illustrated) serving as a light source is disposed so as to face the array substrate 110 on the side opposite to the display surface of the liquid crystal panel 100. Between the liquid crystal panel 100 and the backlight unit, there is provided an optical sheet (not illustrated) for controlling a polarization state, directivity, and the like of light.

The liquid crystal panel 100 is adhered to the curved transparent protective cover 101 described above with the transparent adhesive sheet 102 interposed therebetween, and is housed in a case (not illustrated) having an opening in at least a portion outside the counter substrate 120 in a display area 200 serving as a display surface, together with components (not illustrated) such as the backlight unit and the optical sheet, thereby forming the curved liquid crystal display device 10 of the first preferred embodiment.

The curved liquid crystal display device 10 operates as follows. For example, when an electric signal is received from the control substrate 131, a driving voltage is applied to the pixel electrode 113 and the common electrode 123, and then a direction of each of molecules of the liquid crystal 140 changes according to the driving voltage. Then, light emitted by a curved backlight disposed on a back face side of the liquid crystal panel 100 is transmitted or blocked to an observer side through or with the array substrate 110, the liquid crystal 140, and the counter substrate 120 to allow an image and the like to be displayed on the display surface 200 of the liquid crystal panel 100 curved in a concave shape.

About the curved direction, while the first preferred embodiment has a structure in which the curved liquid crystal display device 10 is curved in a concave shape toward the display surface 200, the curved liquid crystal display device 10 may be curved in a convex shape toward the display surface 200 depending on use.

The liquid crystal panel 100 constituting the curved liquid crystal display device 10 is an example, and other configurations may be used. While it is assumed that an operation mode of the liquid crystal panel 100 is a twisted nematic (TN) mode, other modes such as a supper twisted nematic (STN) mode, a ferroelectric liquid crystal mode, and the like, are available. There is also available a liquid crystal panel using a horizontal electric field method in which the common electrode 123 is provided on the array substrate 110 instead of the counter substrate 120 to apply an electric field laterally to the liquid crystal 140 between the common electrode 123 and the pixel electrode 113.

In addition, the transfer material can be substituted with electrically conductive particles or the like, being mixed in the sealing material 130, and can be eliminated. While there is provided the configuration in which the driving IC is mounted on the control board 131 and electrically connected to the terminal 116 via the FFC132, the driving IC may be disposed on the terminal 116 and a terminal of the driving IC may be directly connected to the terminal 116.

While an inlet port for injecting liquid crystal is not illustrated in the sealing material 130, the inlet port and a sealant for sealing the inlet port are provided in the case of using a vacuum injection method for injecting liquid crystal from the inlet port in a vacuum, as a method for injecting the liquid crystal. In the case of using a droplet injection method in which liquid crystal is placed on one substrate in a droplet shape, and two substrates are adhered in a vacuum to inject the liquid crystal, the inlet port and the sealant can be eliminated.

<Manufacturing method>

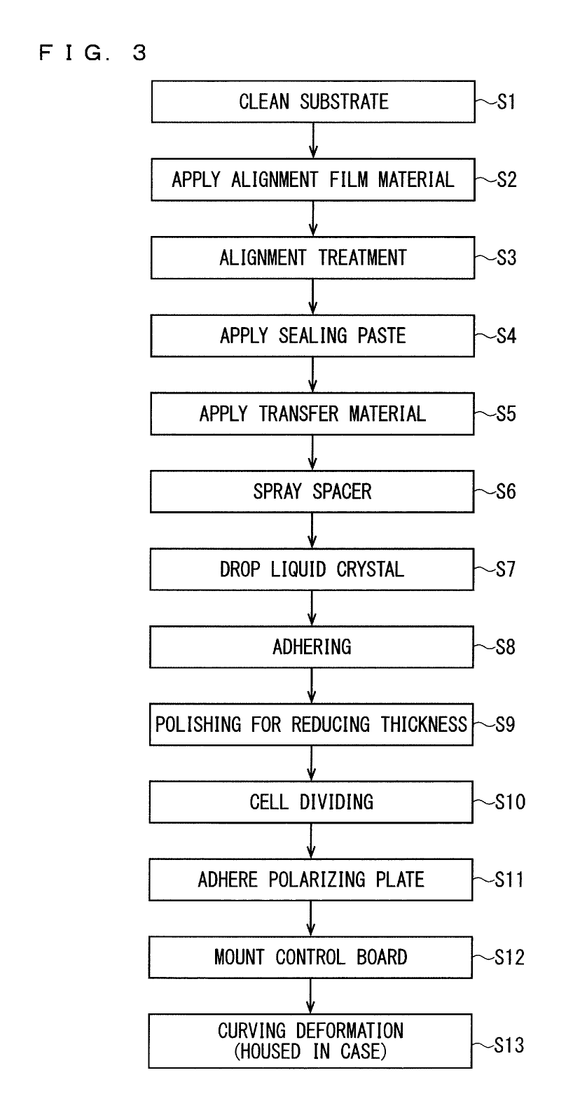

Next, a method for manufacturing the curved liquid crystal display device 10 according to the first preferred embodiment of the present invention will be described with reference to the flowchart illustrated in FIG. 3.

Typically, a liquid crystal panel is manufactured by cutting out a plurality of liquid crystal panels from a mother substrate larger than a final shape by one panel or multiple panels. The processes from step S1 to step S9 and the middle of step S10 in FIG. 3 are performed in a state of a mother substrate.

First, in a substrate preparing step (not illustrated), wiring and the like are formed on a mother array substrate and a mother counter substrate. That is, while steps of forming gate wiring, source wiring, the TFT 114, the insulating film 115, the pixel electrode 113, and the like are performed in the mother array substrate, forming them is similar to that in a manufacturing method for an array substrate in a general liquid crystal panel, and thus detailed description thereof will be eliminated.

After the mother array substrate and the mother counter substrate are prepared, the mother array substrate provided with the pixel electrode 113 is first cleaned in step Si of cleaning a substrate, illustrated in FIG. 3.

Next, an organic film containing polyimide to be a material of the alignment film 112 is applied to one surface of the mother array substrate by a printing method, for example, in step S2 of applying an alignment film material, and then baking treatment is applied to the organic film with a hot plate or the like to dry the organic film.

After that, alignment treatment is performed on the mother array substrate coated with the alignment film material in step S3 to form the alignment film 112. The mother counter substrate provided with the common electrode 123 is also subjected to cleaning, coating of an organic film, and alignment treatment in steps S1 to S3 to form the alignment film 122.

Subsequently, coating treatment of a paste agent of an adhesive to be the sealing material 130 is performed on the main surface of the mother array substrate or the mother counter substrate, provided with the alignment film, in step S4 of applying sealing paste. While a thermosetting resin such as an epoxy type adhesive and an ultraviolet curing type resin can be used as the sealing material 130, for example, an ultraviolet curing type resin is used in the first preferred embodiment because a dropping injection method is used in a liquid crystal injecting step to be performed later. In this seal coating step, a seal dispenser device is used in the first preferred embodiment to discharge a paste agent of an adhesive to be the sealing material 130 from its dispenser nozzle to apply the paste agent to the main surface of the mother array substrate or the mother counter substrate. The paste agent of an adhesive is applied in a pattern shape forming a closed loop that encloses each of display areas of respective liquid crystal panels corresponding to the number of liquid crystal panels to be adhered, thereby forming the sealing material 130.

Next, a transfer material coating step of applying resin, silver paste, or the like, containing conductive particles, to the main surface provided with the alignment film of the mother array substrate or the mother counter substrate is performed (step S5), to form a transfer material serving as an electric conduction path between the substrates.

Next, a spacer spraying step (step S6) of spraying a spacer for maintaining a distance between the substrates at a predetermined distance by a wet method or a dry method is performed on the main surface provided with the alignment film of the mother array substrate or the mother counter substrate.

Step S5 that is the transfer material coating step may be eliminated by containing electrically conductive particulates in the sealing material 130 for adhering substrates to each other to cause a forming step of the sealing material 130 to serve also as step S5. Step S6 that is the spacer spraying step may be eliminated by forming a columnar spacer in the shape of a protrusion for preliminarily determining a distance between substrates on the mother array substrate or the mother counter substrate.

A step of dropping a liquid crystal is performed on the mother array substrate and the mother counter substrate prepared through the above steps with the dropping injection method (step S7), and the mother array substrate and the mother counter substrate are adhered to each other (step S8) to seal the liquid crystal.

More specifically, when the sealing material 130 is formed on the mother counter substrate in the sealing paste applying step (step S4), for example, the liquid crystal 140 in the shape of a liquid droplet is dropped so as to have a predetermined volume in a region surrounded by a pattern of the sealing material 130 on the mother counter substrate.

After the mother array substrate is disposed so as to face the mother counter substrate, and positioned so as to have a predetermined positional relationship in a plane direction, the mother array substrate and the mother counter substrate are adhered to each other in a vacuum. At this time, the paste agent constituting the sealing material 130 formed on the mother counter substrate is spread by being pressed between the mother array substrate and the mother counter substrate. Likewise, the liquid crystal 140 dropped on the mother counter substrate is also spread between the substrates to be uniformly spread in the region surrounded by the sealing material 130, and then the liquid crystal 140 is filled between the substrates.

The sealing material 130 formed as a closed loop pattern is cured on the mother array substrate adhered to the mother counter substrate through the above steps. This step is performed by applying heat suitable for a material of resin constituting the sealing material 130, or by radiating ultraviolet rays, for example. In the present first preferred embodiment, an ultraviolet curable resin is used as the resin constituting the sealing material 130, so that curing treatment is performed by irradiation with ultraviolet rays.

Next, to obtain a curved liquid crystal panel, a slicing-polishing step of scraping the mother array substrate and the mother counter substrate is performed (step S9) so as to facilitate a curving process. This step is performed by scraping a surface of a glass substrate with chemical polishing using a chemical solution or physical polishing using an abrasive, for example. Through the slicing-polishing step, a glass substrate with a thickness of 0.5 mm to 0.7 mm is polished to a thickness of 0.1 mm to 0.2 mm.

Next, an adhered substrate sliced (mother cell substrate) is divided into individual cell substrates corresponding to individual liquid crystal panels in step S10 that is a cell dividing step. The cell dividing step includes not only the step of performing dividing so as to separate each liquid crystal panel simply from the mother cell substrate, but also a specific cutting step of forming a special odd-shaped outline including a straight line and a curved line, or a curved line having a different curvature.

That is, a scribing process is performed first in the cell dividing step such that a disk-shaped blade (scribing wheel) is rolled on a surface of the mother cell substrate along a cutting line along an outline of a complicated odd-shape to form a shallow scratch (crack) in a line shape as a starting point in the surface of the mother cell substrate. The shallow scratch formed in a line shape is called a scribe line.

Next, a breaking process is performed such that pressure is applied to the scribe line formed in the scribing process to divide the mother cell substrate into individual liquid crystal cells (liquid crystal panels). The cutting step including the scribing process and the breaking process is a particularly characteristic step in a method for manufacturing the curved liquid crystal display device 10 of the present first preferred embodiment, so that details thereof will be described below.

Next, a polarizing-plate adhering step (step S11) is performed such that the polarizing plates 141 and 142 are adhered to each of the plurality of cell substrates processed so as to have an outline of a complicated odd-shape (step S11).

Then, step S12, which is a control-board mounting step, is performed such that control boards 131X and 131Y are mounted on the cell board to which the polarizing plates 141 and 142 are adhered, thereby manufacturing a planar liquid crystal panel 100 having an outline of a complicated odd-shape.

Finally, step S13, which is a curving deformation step, is performed such that the curved transparent protective cover 101 composed of a transparent plate having a desired curved shape is adhered to the planar liquid crystal panel 100 with the transparent adhesive sheet interposed therebetween. In the step, the curved transparent protective cover 101 is adhered while the array substrate 110 and the counter substrate 120 are deformed so as to be curved along a curved surface of the curved transparent protective cover 101. The liquid crystal panel 100 deformed in a curved manner by adhering the curved transparent protective cover 101 is housed in a case to complete the curved liquid crystal display device 10 including the liquid crystal panel 100 having the curved display surface 200.

<Cell dividing step>

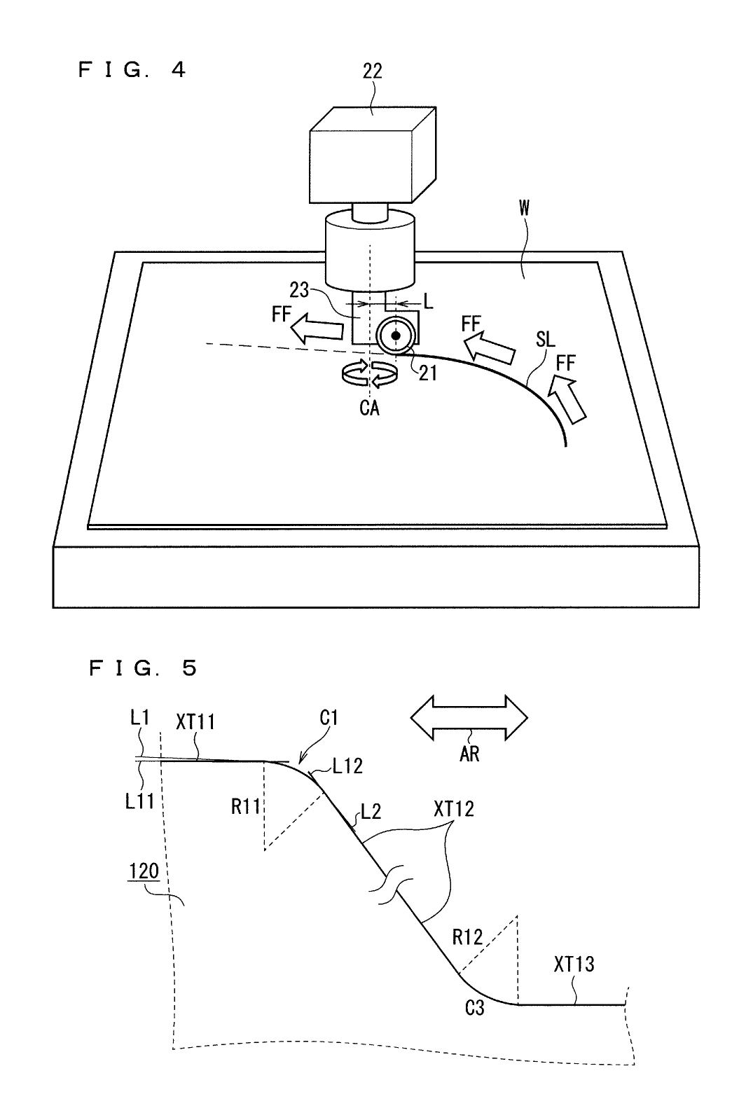

Hereinafter, the cell dividing step will be further described with reference to FIGS. 4 to 6. First, the scribing process will be described with reference to FIG. 4.

In the present first preferred embodiment, the liquid crystal panel has an outline of a complicated odd-shape including a straight line, a curved line, and the like, so that a scribe line for determining the outline also needs to be formed in a line including a straight line, a curved line, and the like. Thus, a scribing treatment apparatus that performs the scribing process also uses a scribing apparatus for a curve, capable of drawing a scribe line in a predetermined shape.

FIG. 4 illustrates an example of forming a curved scribe line using a scribing apparatus for a curve. As illustrated in FIG. 4, the scribing apparatus for a curve includes a disk-like scribing wheel 21, and a movable head 22 provided with a caster mechanism so that the scribing wheel 21 can draw a scribe line SL including a desired curve. Specifically, the scribing wheel 21 is rotatably attached in a leading end portion of a bearing shaft 23 attached rotatably around a vertical axis CA of the movable head 22 movable in an arbitrary direction within a plane with respect to a surface of a glass substrate W.

The bearing shaft 23 has a substantially L-shape, and a rotation shaft of the scribing wheel 21 is provided in a leading end portion bent in the L-shape of the bearing shaft 23 so as to be offset from the vertical axis CA of the bearing shaft 23 by a dimension L. Thus, similarly to a typical caster mechanism, when the movable head 22 is horizontally moved in an arbitrary direction while pressing the scribing wheel 21 against the surface of the glass substrate W, the bearing shaft 23 and the scribing wheel 21 can follow the movable head 22 along a traveling direction of the movable head 22 indicated by arrow FF in the drawing while appropriately changing in angle.

An example of an offset length of the scribing wheel 21 is set within a range of 0.5 mm to 3 mm. When the offset length is too short, the scribing wheel 21 cannot smoothly change in direction at a practical operating speed during change in direction, and when it is too long, a difference in moving direction between the axis CA of the bearing shaft 23 and the rotating shaft of the scribing wheel 21 increases to cause the scribe line to expand during change in direction. Thus, an appropriate length is determined in consideration of a shape of the scribe line SL.

Next, a shape of the scribe line and a shape of the inflection-suppressing region of the final liquid crystal panel 100 (including the array substrate 110 and counter substrate 120) will be described with reference to FIG. 5.

FIG. 5 is an enlarged plan view of the inflection-suppressing regions C1 and C3, and the vicinity thereof, among the inflection-suppressing regions C1 to C4 provided in the notch portion NT of the counter substrate 120 of the liquid crystal panel 100 illustrated in FIG. 2.

In an arcuate curved portion provided in the inflection-suppressing region C1, forming the arcuate portion with a curvature radius R11 exceeding at least 5 mm is practically desirable, in particular. That is, forming the arcuate portion at such a curvature radius enables a curved portion with a curvature radius R11 to be formed with good reproducibility with scribing operation within a practical speed range in the scribing apparatus for a curve described above.

Meanwhile, a curvature radius R11 of 5 mm or less causes the scribing wheel 21 not to change in angle in time for movement of the movable head 22, thereby failing to follow the movable head 22, even when movement speed of the movable head 22, or movement speed of the scribing wheel 21, is set to minimum within a practical speed range the movement speed of the scribing wheel 21 by using the scribing wheel 21 with the caster of the scribing apparatus for a curve described above. As a result, the shape of the curved portion having the curvature radius R11 cannot be drawn correctly as the scribe line to be formed.

From the viewpoint of the effect of suppressing stress concentration when the liquid crystal panel 100 is curved, or the effect of suppressing occurrence of a cullet defect and a break-crack defect of the glass substrate at the time of being curved, it is desirable that the curved portion have a curvature of exceeding 5 mm.

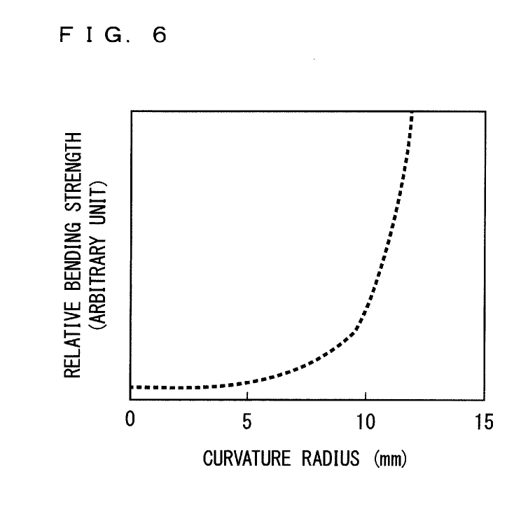

FIG. 6 is a graph illustrating a relationship between a curvature radius of the curved portion provided in the inflection-suppressing region and relative bending strength of the glass substrate when being curved, and the horizontal axis represents the curvature radius (mm) of the inflection-suppressing region, and the vertical axis represents the relative bending strength (arbitrary unit). It is found that the bending strength increases when the curvature radius exceeds 5 mm, and the effect of suppressing the stress concentration begins to be obtained. Particularly, when the curvature radius is 10 mm, the bending strength remarkably increases.

Therefore, it is more desirable that the curved portion provided in the inflection-suppressing region have a curvature radius of exceeding 10 mm to be able to obtain a more remarkable effect of suppressing stress concentration at the time of being curved.

Based on the above, in the present first preferred embodiment, the curvature radius R11 of the curved portion of the inflection-suppressing region C1 provided in a convex shape between the side XT11 of the adjacent straight line and the side XT12 of the straight line, and the curvature radius R12 in the inflection-suppressing region C3 provided in a concave shape between the side XT12 of the adjacent straight line and the side XT13 of the straight line, illustrated in FIG. 5, are both formed to have a curvature radius of 15 mm. In addition, the inflection-suppressing regions C2 and C4 illustrated in FIG. 2 basically have the same shapes symmetrically with the inflection-suppressing regions C1 and C3, respectively, and thus are each similarly formed to have a curved portion with a curvature radius of 15 mm.

In addition to forming the curvature radius to be large as described above, the scribing process is performed to form a scribe line of the inflection-suppressing region in the present first preferred embodiment such that movement speed of the movable head 22, or movement speed of the scribing wheel 21, is set to be slower in the inflection-suppressing region and the vicinity thereof than in other portions to enable the scribing wheel 21 to sufficiently follow the movable head 22 in a moving direction of the movable head 22 of the scribing apparatus illustrated in FIG. 4. For example, the movement speed of the movable head 22 in the inflection-suppressing region and the vicinity thereof is set to 20 mm/sec, and the movement speed of the movable head 22 in the other portions, such as a straight portion and a curved portion, is set to 100 mm/sec.

Regarding a size (length) of the arcuate curved portion provided in the inflection-suppressing region, the inflection-suppressing region is provided from a practical point of view, and is provided in addition to the liquid crystal panel 100 with an external shape formed from a design point of view, so that it is desirable that the size be set to minimum enough to obtain the effect of suppressing stress concentration to prevent a large influence from being exerted to the overall outline design. Thus, the minimum necessary size of the inflection-suppressing region is determined as follows: about 0.1 to 0.2 seconds are required to stabilize an operation direction of the scribing wheel 21 when the moving direction of the scribing wheel 21 changes greatly in the curved portion at the movement speed of the movable head 22, or the movement speed S (mm/sec) of the scribing wheel 21; and a traveling distance (acquired by multiplying S by 0.1 to 0.2 seconds) during that time is determined as the minimum necessary size.

While basically, the movement speed S (mm/sec) of the scribing wheel 21 can be appropriately adjusted within the range of the operating speed peculiar to the scribing apparatus, the size (length) of the curved portion provided in the inflection-suppressing region is about 20 mm when a maximum of the above time required to stabilize an operation direction of the scribing wheel 21 is considered as 0.2 seconds by using a movement speed of 100 mm/sec as a guideline of being typically used. However, as described above, the scribing process is performed in the present first preferred embodiment by setting the movement speed of the movable head 22 slower in the inflection-suppressing region and the vicinity thereof than in the other portions, so that even a curved portion provided in the inflection-suppressing region, having a slightly short length, enables a desired scribe line to be obtained, thereby setting the size to about 15 mm in consideration of the influence on the outline design.

As illustrated in FIG. 5, the straight side XT11 and the straight side XT12 intersect with the curved portion with the curvature radius R11 of the inflection-suppressing region C1 at respective connecting portions so as to be smoothly connected the respective connecting portions to cause little difference in inclination between tangents at the respective connecting portions. Specifically, also in consideration of an error range at the time of formation, it is desirable to form a scribe line such that a difference between an inclination of each of the tangents L11 and L12 of the corresponding straight side XT11 and straight side XT12, and an inclination of each of the tangents L1 and L2 of the respective connecting portions where the corresponding straight side XT11 and straight side XT12 intersect the curved portion, is within one degree from the viewpoint of suppressing stress concentration.

<Effect>

The curved liquid crystal display device 10 of the first preferred embodiment described above is configured such that a curved portion having a predetermined curvature is provided in a portion of an inflection point formed between straight lines each extending at a different angle to form a inflection-suppressing region in the outline of each of the array substrate 110 and the counter substrate 120 constituting the non-rectangular liquid crystal panel 100 in an odd-shape including a straight line and a curved line. This configuration suppresses stress concentration when the liquid crystal panel 100 is curved, thereby enabling occurrence of a cullet defect and a break-crack defect of the glass substrate to be suppressed.

In particular, when the arcuate curved portion constituting the inflection-suppressing region is formed to have a curvature radius exceeding 5 mm of the arc, stress concentration can be suppressed and the arc with a desired curvature radius can be formed with good reproducibility with scribing operation within a practical speed range. In addition, when the curved portion is formed so as to have a curvature radius exceeding 10 mm, stress concentration can be more remarkably suppressed.

### Second Preferred Embodiment

<Device configuration>

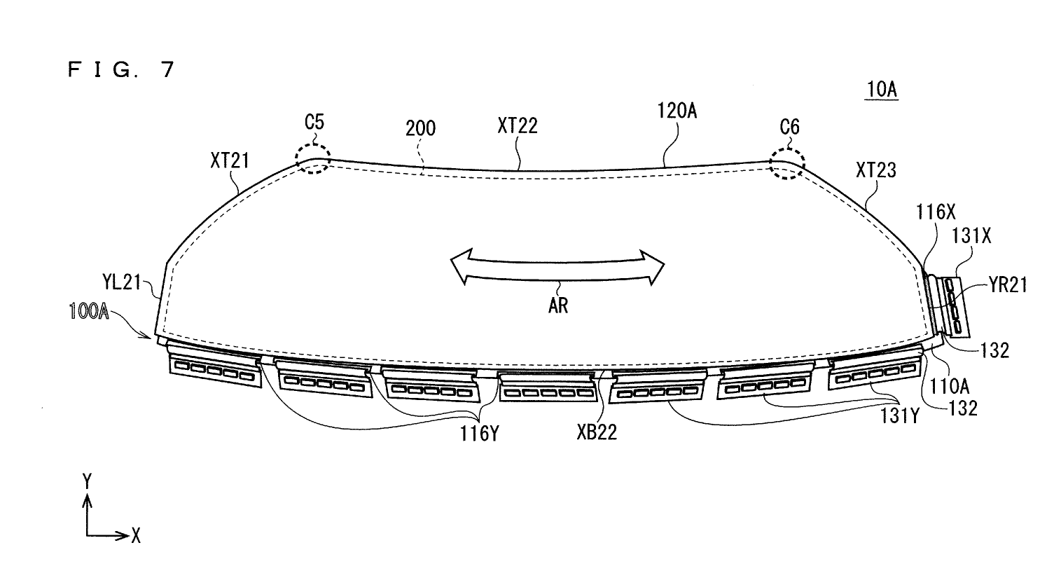

FIG. 7 is a perspective view illustrating a configuration of a curved liquid crystal display device 10A according to a second preferred embodiment of the present invention, and is mainly a perspective view of a liquid crystal panel 100A by eliminating a curved transparent protective cover 101 and the like, as with the curved liquid crystal display device 10 illustrated in FIG. 2. Hereinafter, portions changed from the first preferred embodiment will be mainly described.

The liquid crystal panel 100A of the present second preferred embodiment has a characteristic configuration in which the liquid crystal panel 100A has a curved shape and includes an array substrate 110A and a counter substrate 120A each of which has an outline that is not a rectangular shape but a complicated odd-shape, as with the liquid crystal panel 100 of the first preferred embodiment. That is, the liquid crystal panel 100A has an outline composed of a straight line and a curved line, as with the liquid crystal panel 100, but does not include a notch portion in an upper side XT22 in a lateral direction (Y-direction) perpendicular to a longitudinal direction of the liquid crystal panel 100A, the upper side XT22 being straight.

The side XT22 is provided on its opposite ends a side XT21 and a side XT23 each of which is composed of a convex curved portion with a relatively large curvature outward from the substrate, is continuous with the side XT22. The side XT22 has a length shorter than that of a lower side XB22 opposite to the side XT22, and the sides XT21 and XT23 incline toward the side XB22.

The sides XT21 and XT23 are provided on their sides opposite to their portions continuous with the side XT22 with linear sides YL21 and YR21, respectively, so as to be continuous. The lower side XB22 of the liquid crystal panel 100A in the lateral direction (Y-direction) is linear, and is continuous with the side YL21 and the side YR21. As described above, the liquid crystal panel 100A with the outline composed of the sides XT21 to XT23, the side YL21, the side YR21, and the side XB22 has a complicated odd-shaped outline close to a hexagon.

Between the side XT22 and the side XT21, and between the side XT22 and the side XT23, inflection-suppressing regions C5 and C6 are provided, respectively. The inflection-suppressing regions C5 and C6 are arcuate curved portions each having a predetermined curvature so as to smoothly connect the adjacent sides to each other, thereby suppressing a great change in direction of the outline.

Next, an outline of the liquid crystal panel 100A in a non-curved state will be described taking each side constituting the outline of the counter substrate 120A illustrated in FIG. 7 as an example. As illustrated in FIG. 7, in the counter substrate 120A, each of the left side YL21, the right side YR21, the lower side XB22, and the upper side XT22, facing the drawing, is a straight line, and in the non-curved state, the left side YL21 and the right side YR21 are perpendicular to the lower side XB22 in plan view. In addition, the sides XT21 and XT23 on the corresponding left and right sides of the upper side XT22 are each composed of a convex curve with a relatively large curvature.

Except for the characteristic outline of the liquid crystal panel 100A described above, each configuration and a basic manufacturing method of other liquid crystal panels 100A are the same as the configuration and the manufacturing method of the liquid crystal panel 100 of the first preferred embodiment, and thus duplicated description will be eliminated.

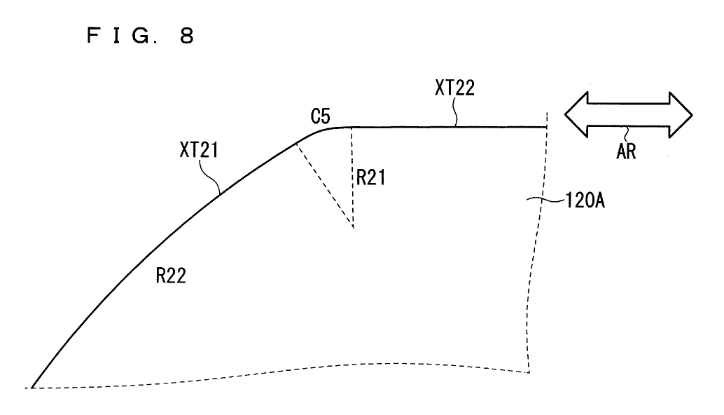

Next, a shape of the scribe line and a shape of the inflection-suppressing region of the final liquid crystal panel 100A (including the array substrate 110A and counter substrate 120A) will be described with reference to FIG. 8.

FIG. 8 is an enlarged plan view of an inflection-suppressing region C5 and its vicinity of the inflection-suppressing regions C5 and C6 provided in the counter substrate 120A of the liquid crystal panel 100A illustrated in FIG. 7. The inflection-suppressing region C5 in the liquid crystal panel 100A is provided between the straight side XT22 and the side XT21 composed of a curved line in a convex shape with a relatively large curvature radius R22, and the straight line in the first preferred embodiment, and is different from the inflection-suppressing regions C1 to C4 provided between the straight portion and the straight portion in the first preferred embodiment. However, in an arcuate curved portion provided in the inflection-suppressing region C5, forming the arcuate portion with a curvature (curvature radius) R21 exceeding at least 5 mm is practically desirable, as in the arcuate portion provided in each of the inflection-suppressing regions C1 to C4 in the liquid crystal panel 100 of the first preferred embodiment. The same applies to an arcuate portion provided the inflection-suppressing region C6.

In addition, the curved portion provided in the inflection-suppressing region having a curvature radius of exceeding 10 mm enables obtaining a more remarkable effect of suppressing stress concentration at the time of being curved, as in the first preferred embodiment.

Thus, also in the present second preferred embodiment, the curved portion of each of the inflection-suppressing regions C5 and C6, provided between a straight side and a curved side adjacent to each other, is formed to have a curvature radius of 15 mm.

In addition, the same manufacturing method as that in the first preferred embodiment is used also in the second preferred embodiment, so that a scribing process is performed by setting movement speed of the movable head 22 of the scribing apparatus illustrated in FIG. 4 slower in at least the inflection-suppressing regions C5 and C6 and in the vicinity thereof than in the other portions. Thus, the curved portion provided in the inflection-suppressing region is formed to have a length of about 15 mm in consideration of influence on an outline design.

<Effect>

The curved liquid crystal display device 10A of the second preferred embodiment described above is configured such that a curved portion having a predetermined curvature is provided in a portion of an inflection point formed between a straight side and a curved side, adjacent to each other, to form a inflection-suppressing region in the outline of each of the array substrate 110A and the counter substrate 120A constituting the non-rectangular liquid crystal panel 100A in an odd-shape including a straight line and a curved line. This configuration suppresses stress concentration when the liquid crystal panel 100A is curved, thereby enabling occurrence of a cullet defect and a break-crack defect of a glass substrate to be suppressed.

In particular, when the arcuate curved portion constituting the inflection-suppressing region is formed to have a curvature radius exceeding 5 mm of the arc, stress concentration can be suppressed and the arc with a desired curvature radius can be formed with good reproducibility with scribing operation within a practical speed range. In addition, when the curved portion is formed so as to have a curvature radius exceeding 10 mm, stress concentration can be more remarkably suppressed.

### Third Preferred Embodiment

While the curved liquid crystal display devices 10 and 10A each having a specific odd-shape to which the present invention is applied are exemplified in the first and second preferred embodiments according to the present invention described above, the application of the present invention is limited thereto. Various modifications are available for the desirable shape of the inflection-suppressing region in the side along the curved direction of the liquid crystal panel, so that an example of the desirable shape of the inflection-suppressing region will be described systematically as a third preferred embodiment.

### Application Example 1: Case where Line and Curve are Adjacent

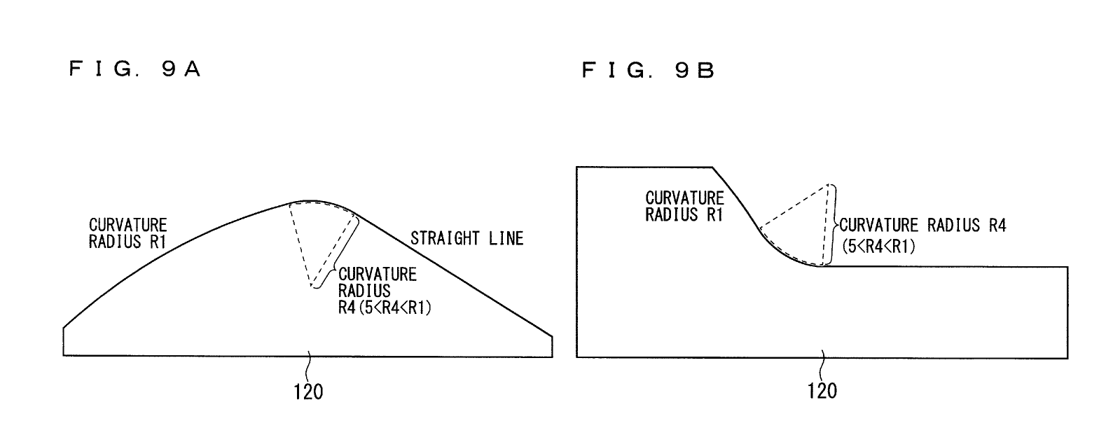

FIG. 9A and 9B each illustrate an example of an inflection-suppressing region provided in a portion where a side composed of an arcuate curve with a curvature radius R1 (mm), which is a relatively large curvature (large curvature radius), and a side composed of an straight line are adjacent to each other. FIG. 9A illustrates a state where a convex curved portion is provided in a convex corner portion between a side composed of an arcuate curve with a curvature radius R1 and a side composed of an straight line, or a state where an intersection of tangents of the two adjacent sides is formed outside a substrate. FIG. 9B illustrates a state where a concave curved portion is provided in a concave corner portion between a side composed of an arcuate curve with a curvature radius R1 and a side composed of an straight line the side composed of the arcuate curve with the curvature radius R1 and the side composed of the straight line, or a state where an intersection of tangents of the two adjacent sides is formed inside the substrate.

The convex or concave curved portion provided between the side composed of a curve and the side composed of a straight line as described above needs to be formed to have a curvature radius R4 (mm) within a range having an upper limit value smaller than the curvature radius R1 (mm) of the curve from the viewpoint of suppressing a variation in a side along a curved direction of a liquid crystal display panel, or an inflection therein. That is, it is necessary to satisfy the following relationship: R4 (mm)<R1 (mm). Meanwhile, as described in the second preferred embodiment, it is desirable that a lower limit value satisfy the following relationship: 5 mm<R4 (mm), to enable forming an arc having the curvature radius R4 with good reproducibility with scribing operation in a practical speed range. It is more desirable that the lower limit value satisfy the following relationship: 10 mm<R4 (mm), to obtain an effect of more remarkably suppressing stress concentration.

### Application Example 2: Case where Curves are Adjacent

FIG. 10A and 10B each illustrate an example of an inflection-suppressing region provided in a portion where a side composed of an arcuate curve with a curvature radius R2 (mm), which is a relatively large curvature (large curvature radius), and a side composed of an arcuate curve with a curvature radius R3 (mm), which is a relatively large curvature (large curvature radius), are adjacent to each other. FIG. 10A illustrates a state where a convex curved portion is provided in a convex corner portion between the two curves, or a state where an intersection of tangents of the two adjacent sides is formed outside a substrate. FIG. 10B illustrates a state where a concave curved portion is provided in a concave corner portion between the two curves, or a state where an intersection of tangents of the two adjacent sides is formed inside the substrate.

While these shapes are each not used in the outline of the curved liquid crystal display devices 10 and 10A of the corresponding first and second preferred embodiments, the convex or concave curved portion needs to be formed to have a curvature radius R5 (mm) within a range having an upper limit value smaller than the curvature radii R2 (mm) and R3 (mm) of the curve from the viewpoint of suppressing a variation in a side along a curved direction of a liquid crystal display panel, or an inflection therein. That is, it is necessary to satisfy the following relationships: R5 (mm)<R2 (mm); and R5 (mm)<R3 (mm). Meanwhile, as with the case described in each of the first and second preferred embodiments, it is desirable that a lower limit value satisfy the following relationship: 5 mm<R5 (mm), to enable forming an arc having the curvature radius R5 with good reproducibility with scribing operation in a practical speed range. It is more desirable that the lower limit value satisfy the following relationship: 10 mm<R5 (mm), to obtain an effect of more remarkably suppressing stress concentration.

### Application Example 3: Case where Lines are Adjacent

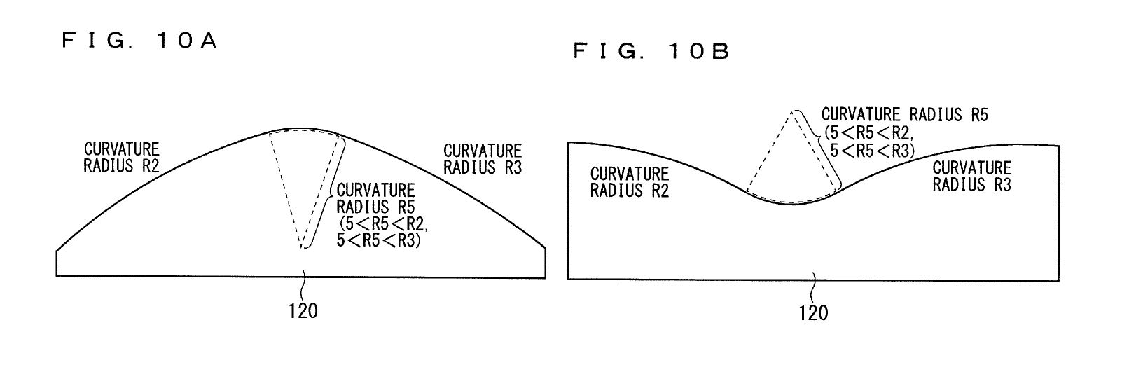

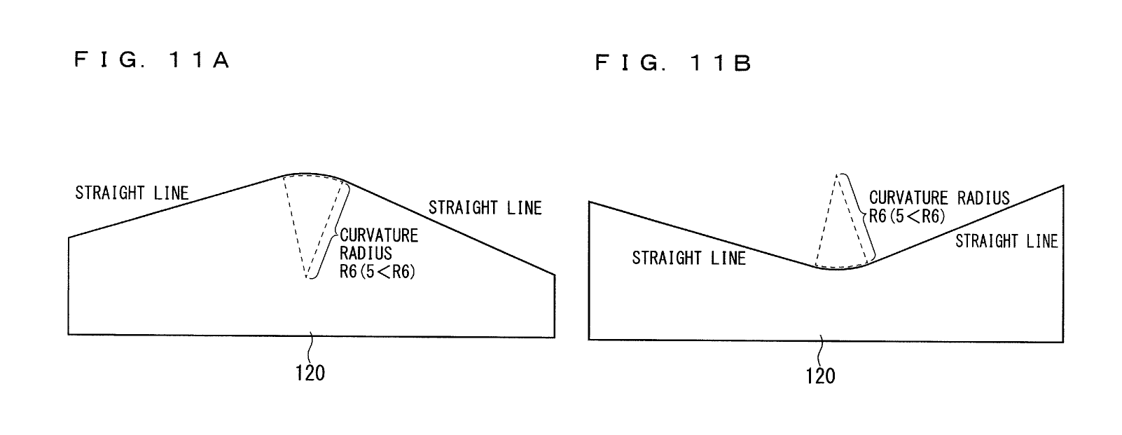

FIG. 11A and 11B each illustrate an example of an inflection-suppressing region provided in a portion where a side composed of a straight line and a side composed of a straight line are adjacent to each other. FIG. 11A illustrates a state where a convex curved portion is provided in a convex corner portion between the two straight lines, or a state where an intersection of tangents of the two adjacent sides is formed outside a substrate. FIG. 11B illustrates a state where a concave curved portion is provided in a concave corner portion between the two straight lines, or a state where an intersection of the two adjacent sides is formed inside the substrate.

These shapes are each similar to that of each of the inflection-suppressing regions C1 to C4 of the curved liquid crystal display device 10 of the first preferred embodiment, and, irrespective of the curved portion being convex or concave, it is desirable that a range of a curvature radius R6 (mm) of each of the curved portions have a lower limit value that satisfies the following relationship: 5 mm<R6 (mm), similarly to the first preferred embodiment and the second embodiment, to enable forming an arc having the curvature radius R6 with good reproducibility with scribing operation in a practical speed range. It is more desirable that the lower limit value satisfy the following relationship: 10 mm<R6 (mm), to obtain an effect of more remarkably suppressing stress concentration. Meanwhile, while it is difficult to uniquely set an upper limit because two opposite sides of the curved portion are straight lines, the upper limit of the curvature radius R6 (mm) can be set in accordance with an angle formed by straight lines intersecting with each other and a length of 20 mm of the curved portion, based on a guideline of a length of a curved portion provided in an inflection-suppressing region that is about 20 mm, as described in the first preferred embodiment. Because an intersection of the straight lines extending inward from respective opposite ends of the curved portion so as to be perpendicular to the corresponding straight lines is the center portion of an arc of the curved portion as illustrated in FIGS. 11A and 11B. This allows the corresponding curvature radius to be determined.

Setting a curvature of the curved portion within the upper limit value of the curvature radius R6 set as described above enables obtaining an effect of suppressing stress concentration at the time when a liquid crystal display panel is curved without greatly affecting the overall outline shape design.

While the convex curved portion or the concave curved portion is provided at the corner portion to form the inflection-suppressing region in the above-described FIGS. 9A to 11B, stress concentration due to curving and progress of micro cracks become more conspicuous in the concave corner portion. In addition, as the glass substrate is relatively reduced in length in a direction perpendicular to the curved direction, or in width, an absolute value of bending strength of the glass substrate itself also decreases in the concave corner portion.

As described above, influence due to curving increases more in the concave corner portion, so that providing the inflection-suppressing region at the concave corner portion obtains a more remarkable effect of suppressing a cullet defect and a break-crack defect of the glass substrate at the time of curving it.

The range of the curvature radius of the curved portion provided at the concave corner portion is basically the same as the range of the curvature radius of the curved portion provided at the convex corner portion. However, in consideration of decrease in an absolute value of bending strength of the glass substrate in the concave corner portion as described above, it is desirable to form the curved portion in the concave corner portion so as to have a curvature radius exceeding 20 mm from the viewpoint of securing a wider margin against bending resistance. In addition, each of the convex and concave corner portions in the above-described FIGS. 9A to 11B has an obtuse angle exceeding 90 degrees that is formed by intersection of the tangents of the respective opposite end sides of the inflection-suppressing region, as illustrated. This means that when the inflection-suppressing region is also provided in a portion where formation of an inflection point does not particularly cause a problem at the time without being curved, occurrence of a crack, a break, and the like of the glass substrate due to stress concentration at the time of curving it can be suppressed.

In addition, an obtuse angle is formed by intersection of the tangents of the two respective adjacent sides provided so as to sandwich the corresponding one of the opposite ends of the inflection-suppressing region. Then, as a degree of inflection of each of the sides at the respective opposite ends of the inflection-suppressing region, or a degree of change in extension direction, increases, an effect of suppressing stress concentration during curving operation is increased by providing the inflection-suppressing region.

Specifically, when a degree of inflection of two adjacent sides provided so as to sandwich the inflection-suppressing region, or a change in angle due to the change in extension direction of each of the sides, is 30 degrees or more, a suppressing effect caused by providing the inflection-suppressing region increases. In terms of the angle formed by intersection of the tangential lines of the respective opposite end sides of the inflection-suppressing region, when the angle is 150 degrees or less, it can be said that the suppressing effect caused by providing the inflection-suppressing region increases.

This condition also applies to the inflection-suppressing regions C1 to C4 of the first preferred embodiment and the inflection-suppressing regions C5 and C6 of the second preferred embodiment. Then, it can be said that this aspect increases an effect of suppressing stress concentration, caused by providing the inflection-suppressing regions C1 to C6.

### Application Example 4: Case where Adjacent Curve is Concave

While there is described the example in which the curve constituting the side adjacent to the inflection-suppressing region is a convex shape protruding toward the outside of the substrate in each of the first and second preferred embodiments, and the application examples 1 and 2, described above, even a curve having a concave shape recessed toward the inside of the substrate enables obtaining an effect of suppressing stress concentration by providing the inflection-suppressing region,

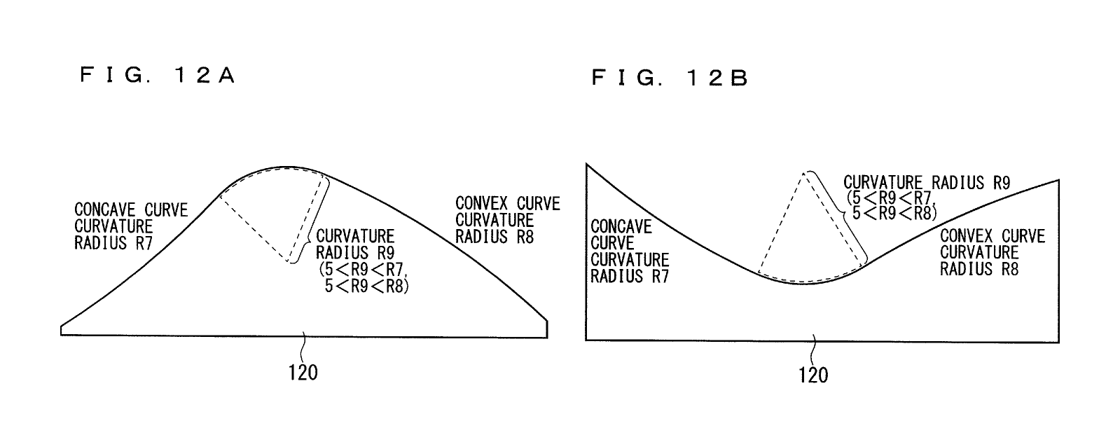

FIG. 12A and 12B each illustrate an example of an inflection-suppressing region provided in a portion where a side composed of a concave curve with a curvature radius R7 (mm), which is a relatively large curvature (large curvature radius), and a side composed of a convex curve with a curvature radius R8 (mm), which is a relatively large curvature (large curvature radius), are adjacent to each other. FIG. 12A illustrates a state where a convex curved portion is provided in a convex corner portion between the two curves, or a state where an intersection of tangents of the two adjacent sides is formed outside a substrate. FIG. 12B illustrates a state where a concave curved portion is provided in a concave corner portion between the two curves, or a state where an intersection of tangents of the two adjacent sides is formed inside the substrate.

From the viewpoint of suppressing inflection, each of the convex curved portion and the concave curved portion needs to be formed to have a curvature radius R9 (mm) within a range having an upper limit value smaller than the curvature radii R7 (mm) and R8 (mm) of the respective curves. That is, it is necessary to satisfy the following relationships: R9 (mm)<R7 (mm); and R9 (mm)<R8 (mm). Meanwhile, it is desirable that a lower limit value satisfy the following relationship: 5 mm<R9 (mm), to enable forming an arc having the curvature radius R9 with good reproducibility with scribing operation in a practical speed range. It is more desirable that the lower limit value satisfy the following relationship: 10 mm<R9 (mm), to obtain an effect of more remarkably suppressing stress concentration.

As described above, even when the curve adjacent to the inflection-suppressing region is concave, providing the inflection-suppressing region having the arcuate curved portion having the predetermined curvature radius enables obtaining an effect of suppressing stress concentration.

### Application Example 5: Case where Inflection-Suppressing Region is in Non-Arcuate Shape

The curved portion of the inflection-suppressing region is described as having an arcuate shape in the first and second preferred embodiments, and the application examples 1 to 4, described above. However, when an obtuse angle is formed by intersection of the tangents of the two respective adjacent sides provided so as to sandwich the corresponding one of the opposite ends of the inflection-suppressing region, there is originally a slight stress concentration. Thus, even when an inflection-suppressing region approximated by a polygon composed of a plurality of consecutive straight lines is used instead of an arcuate one, a great change in direction of an outline can also be suppressed. In other words, the inflection-suppressing region may be composed of a polygonal portion that is composed of a plurality of straight lines connected so as to reduce a difference in inclination among their tangents to approximate an arc.

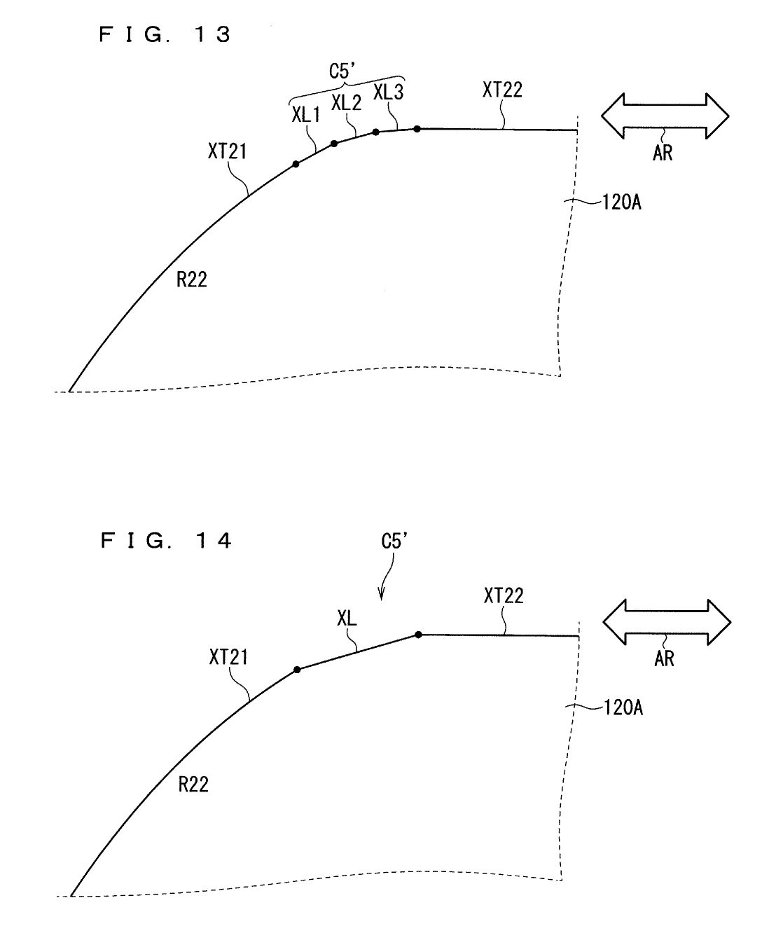

FIG. 13 is a view corresponding to FIG. 8 that is the enlarged plan view of the inflection-suppressing region C5 of the liquid crystal panel 100A of the second preferred embodiment and the vicinity thereof, and an inflection-suppressing region C5′ is provided between the straight side XT22 and the side XT21 composed of a curved line in a convex shape with a relatively large curvature radius R22.

As illustrated in FIG. 13, the inflection-suppressing region C5′ is not an arc, but is composed of three continuous straight lines XL1 to XL3 that gradually change in angle to form a polygonal shape approximating an arc.

When the straight lines XL1 to XL3 constituting the inflection-suppressing region C5′ are each formed so as to have an overall length (total of lengths) of the straight lines XL1 to XL3 of 20 mm or less, as with the length of the arcuate inflection-suppressing region, a great change in direction of an outline can also be suppressed.

In the example of FIG. 13, the inflection-suppressing region C5′ is composed of the three straight lines XL1 to XL3. However, increasing the number of straight lines allows a polygonal portion to be closer to an arc, so that a difference in inclination among the straight lines can be set within a range of 1 degree or less. This enables suppressing a great change in direction of an outline as in the case where the inflection-suppressing region having the arcuate curved portion is provided.

When a large obtuse angle, such as exceeding 150 degrees, is formed by intersection of the tangents of the two respective adjacent sides provided so as to sandwich the corresponding one of the opposite ends of the inflection-suppressing region, a level of inflection decreases. In this case, the inflection-suppressing region C5′ may be composed of one straight line XL with a length of 20 mm or less that is provided so as to connect the adjacent sides XT21 and XT22, as illustrated in FIG. 14, for example. That case also enables obtaining an effect of suppressing inflection to some extent as compared with the case where no inflection-suppressing region is provided.

In the present invention, each of the embodiments may be freely combined, or appropriately modified, within the scope of the invention, and any of the embodiments may be eliminated.

While the invention has been shown and described in detail, the foregoing description is in all aspects illustrative and not restrictive. It is therefore understood that numerous modifications and variations can be devised without departing from the scope of the invention.

What is claimed is:

1. A display device comprising a display panel having a non-rectangular outline, incorporated in a curved state,
the display panel including a glass substrate,
the glass substrate being provided in its side along a curved direction of the display panel with an inflection point of an outline composed of at least one of a combination of curved lines or straight lines, and a combination of a curved line and straight line,
the glass substrate including a curved portion in an arc-like shape with a first curvature radius in a portion including the inflection point of the outline, serving as an inflection-suppressing region for suppressing a variation in the side along the curving direction, and
the curved portion being formed to have the first curvature radius exceeding 5 mm.

2. The display device according to claim 1, wherein
the inflection point of the outline is an inflection point between a straight line and an arcuate curve with a second curvature radius, and
the first curvature radius is smaller than the second curvature radius.

3. The display device according to claim 1, wherein
the inflection point of the outline is an inflection point between an arcuate first curve with the second curvature radius and an arcuate second curve with a third curvature radius, and
the first curvature radius is smaller than the second and third curvature radii.

4. The display device according to claim 1, wherein the inflection point of the outline is an inflection point between straight lines extending at respective angles different from each other.

5. The display device according to claim 1, wherein
the inflection-suppressing region includes tangents of respective connecting portions each connecting at least one of the combination of curved lines or straight lines, and the combination of the curved line and straight line to the curved portion, the connecting portions being provided on respective opposite sides so as to sandwich the curved portion, and
a difference in inclinations of the tangents is 1 degree or less.

6. The display device according to claim 1, wherein the inflection-suppressing region is provided in a portion where an obtuse angle is formed by intersection of tangents of the respective at least one of the combination of curved lines or straight lines, and the combination of the curved line and straight line on the corresponding opposite sides provided so as to sandwich the curved portion.

7. The display device according to claim 6, wherein the inflection-suppressing region is provided in a portion where an angle of 150 degrees or less is formed by intersection of the tangents of the respective at least one of the combination of curved lines or straight lines, and the combination of the curved line and straight line on the corresponding opposite sides provide so as to sandwich the curved portion.

8. The display device according to claim 1, wherein the curved portion has an arc with a length of 20 mm or less.

9. The display device according to claim 1, wherein the curved portion has the first curvature radius exceeding 10 mm.

10. The display device according to claim 1, wherein the curved portion includes at least one of a convex curved portion protruding toward an outside of the glass substrate and a concave curved portion recessed toward the inside of the glass substrate.

11. The display device according to claim 10, wherein the concave curved portion has the first curvature radius exceeding 20 mm

12. The display device according to claim 1, wherein the display panel is adhered and fixed to a transparent protective plate having a curved surface, and is held in a curved shape.

13. A display device comprising a display panel having a non-rectangular outline, incorporated in a curved state,
the display panel including a glass substrate,
the glass substrate being provided in its side along a curved direction of the display panel with an inflection point of an outline composed of at least one of the combination of curved lines or straight lines, and the combination of the curved line and straight line,
the glass substrate including a polygonal portion approximating an arc in a portion including the inflection point of the outline, serving as an inflection-suppressing region for suppressing a variation in the side along the curving direction, and
the polygonal portion being composed of a plurality of straight lines connected so as to reduce a difference in inclinations of respective tangents.

14. The display device according to claim 13, wherein the inflection-suppressing region is provided in a portion where an obtuse angle formed by intersection of tangents of the respective at least one of the combination of curved lines or straight lines, and the combination of the curved line and straight line on the corresponding opposite sides provided so as to sandwich the polygonal portion is the obtuse angle.

15. The display device according to claim 13, wherein the polygonal portion has an overall length of 20 mm or less.

16. A display device comprising a display panel having a non-rectangular outline, incorporated in a curved state,
the display panel including a glass substrate,
the glass substrate being provided in its side along a curved direction of the display panel with a portion where an angle formed by intersection of tangents of respective at least one of the combination of curved lines or straight lines, and the combination of the curved line and straight line changes, the portion including a straight line having an overall length of 20 mm or less, the straight line connecting the respective combinations of at least curves or straight lines.

17. A method for manufacturing a display device including a display panel having a non-rectangular outline, incorporated in a curved state, the method comprising the steps of:
a scribing process of forming a scribe line in a glass substrate constituting the display panel with a scribing wheel in a disk-like shape;
a breaking process of dividing the glass substrate along the scribe line by applying pressure to the scribe line; and
curving the display panel including the glass substrate divided in the breaking process by adhering and fixing the display panel to a transparent protective plate with a curved surface,
the step of the scribing process including a forming step of forming the scribe line so as to form an inflection point of an outline composed of at least one of the combination of curved lines or straight lines, and the combination of the curved line and straight line, on a side along a curved direction of the display panel, while forming an inflection-suppressing region for suppressing a variation in the side along the curved direction in a portion including the inflection point of the outline.

18. The method for manufacturing a display device, according to claim 17, wherein the scribing process is performed by setting movement speed of the scribing wheel slower in the inflection-suppressing region and vicinities of the inflection-suppressing region than in other portions.
